(19) United States
(12) Patent Application Publication
(10) Pub. No.: US 2016/0016126 A1
(43) Pub. Date: Jan. 21, 2016

(54) Fluoropolymer Article For Bacterial Filtration

(71) Applicant: W. L. Gore & Associates, Inc, Newark, DE (US)

(72) Inventors: Lei Zhang, Newark, DE (US); Michael Wikol, Landenberg, PA (US); Jason J. Strid, Elkton, MD (US)

(21) Appl. No.: 14/336,031

(22) Filed: Jul. 21, 2014

(51) Int. Cl. B01D 71/36; B01D 69/02; B01D 69/12

(52) U.S. Cl. CPC B01D 71/36; B01D 69/12; B01D 69/02; B01D 2325/48; B01D 2325/36

(57) ABSTRACT

A sterilizing grade filter including at least two non-sterile fluoropolymer membranes positioned in a stacked configuration is provided. The fluoropolymer membranes a bubble point from about 10 psi to about 50 psi, a thickness less than about 10 microns, and a mass/area less than about 10 g/m². The non-sterile fluoropolymer membranes are is separated from each other by a distance d, which may be less than about 100 microns. The fluoropolymer membranes may be laminated or co-expanded to produce a composite stacked filtration material. In exemplary embodiments, at least one of the fluoropolymer membranes is an expanded polytetrafluoroethylene membrane. In one embodiment, the surface morphology of the fluoropolymer membranes are substantially the same and contain no or substantially no free fibrils. Methods of producing a sterilizing grade filter are also provided.

### FIELD

The present disclosure relates generally to bacterial filtration, and more specifically to a multilayered filtration article that meets bacterial retention requirements of a sterilizing grade filter.

### BACKGROUND

Bacterial contamination poses a threat to the safety of biopharmaceuticals, and food and beverage streams. To that end, filters have been developed to provide removal of bacteria from such process streams. Known filters that provide bacterial filtration typically employ one or more fluoropolymer membranes. Some such filters build in a safety net and employ two layers of membranes to provide sterility assurance. That is, even if there is some passage of bacteria through the first membrane layer, the presence of the second membrane layer will presumably retain any bacteria that was not retained in the first layer. However, the flow rate of a filter is often significantly lowered with such a dual layered configuration.

In order to improve flow rate, attempts were made to use thinner membranes for this application. However small pore sizes (high bubble point) were needed to retain all the bacteria in the fluid stream so as to meet bacterial retention requirements of a sterilizing grade filter. Although high bubble points (or small pore size) membranes may have effective bacterial retention, they tend to suffer from low capacity (or throughput). Additionally, their flow rate per unit area is highly compromised and the ability to correlate bubble point and thickness to bacterial retention is lowered.

As it is desirable to improve the flow rate per unit area of filtration without compromising bacterial retention characteristics, there remains a need for a porous membrane which provides high flow rate per unit area while meeting the bacterial retention requirements of a sterilizing grade filter.

### SUMMARY

One embodiment of the invention relates to a stacked bacterial filter material that includes (1) a first non-sterile fluoropolymer membrane having a first major surface and a second major surface and (2) a second non-sterile fluoropolymer membrane positioned on the first or second major surface a distance d from the first non-sterile fluoropolymer membrane. The distance d may be less than 100 microns. The first and second fluoropolymer membranes each have a bubble point from about 10 psi to about 50 psi and a thickness less than about 10 microns. The first and second fluoropolymer membranes may also have a mass/area from about 0.1 g/m² to about 2 g/m². Additionally, the first and second major surfaces are substantially free of free fibrils. In one or more embodiment, at least one of the first and second fluoropolymer membranes is an expanded polytetrafluoroethylene (ePTFE) membrane. Additionally, the stacked bacterial filtration material passes the Bacterial Retention Requirements for a Sterilizing Grade Filter and is a sterilizing grade filter.

A second embodiment of the invention relates to a bacterial filtration material that includes (1) a stacked filter material and (2) a first fibrous layer positioned on the stacked filter material. The bacterial filtration material is a sterilizing grade filter. The stacked filter material includes (1) a first non-sterile fluoropolymer membrane having a first major surface and a second major surface and (2) a second non-sterile fluoropolymer membrane positioned on the first major surface a distance from the first major surface. The distance d may be less than 100 microns. In addition, the first and second fluoropolymer membranes each have a bubble point from about 10 psi to about 50 psi and a thickness less than about 10 microns. In an exemplary embodiment, at least one of the first and second fluoropolymer membranes is an expanded polytetrafluoroethylene. The first and second fluoropolymer membranes may be derived from a parent fluoropolymer membrane divided in a direction perpendicular to a length direction of the parent fluoropolymer membrane. In at least one embodiment, a second fibrous layer is positioned on the stacked filter material on a side opposing the first fibrous layer.

A third embodiment of the invention relates to a bacterial filtration material that includes (1) a stacked filter material and (2) a first fibrous layer positioned on the stacked filter material. The stacked filter material includes (1) a first non-sterile fluoropolymer membrane having a first major surface and a second major surface and (2) a second non-sterile fluoropolymer membrane positioned on the first major surface a distance from the first major surface. The distance d may be less than 100 microns. Additionally, the first and second fluoropolymer membranes may be derived from a parent fluoropolymer membrane divided in a direction perpendicular to a length direction of the parent fluoropolymer membrane. In addition, the first and second fluoropolymer membranes each have a bubble point from about 10 psi to about 50 psi, a thickness less than about 10 microns, and a mass/area from about 0.1 g/m² to about 2 g/m². The stacked bacterial filtration material is a sterilizing grade filter.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 a schematic illustration of layers of material within a filtration material according to at least one embodiment of the invention;

FIG. 2 is a schematic illustration of the orientation of materials within the stacked filter material according to at least one embodiment of the invention;

FIG. 3 is an exploded view of a filtration device containing a pleated filtration medium in accordance with an embodiment of the present invention;

FIG. 4 is a scanning electron micrograph of the top surface of an ePTFE membrane for use in a stacked filter taken at 5000× in accordance with one embodiment of the invention;

FIG. 5 is a scanning electron micrograph of the bottom surface of the ePTFE membrane of FIG. 4 taken at 4500× according to one embodiment of the invention;

FIG. 6 is a scanning electron micrograph of a cross-section of the ePTFE membrane of FIG. 4 taken at 10,000× in accordance with another embodiment of the invention;

FIG. 7 is a scanning electron micrograph of the top surface of an ePTFE membrane for use in a stacked filter taken at 5000× in accordance with one embodiment of the invention;

FIG. 8 is a scanning electron of the bottom surface of the ePTFE membrane of FIG. 7 taken at 5000× according to another embodiment of the invention; and

FIG. 9 is a scanning electron micrograph of a cross-section of the ePTFE membrane of FIG. 7 taken at 10,000× in accordance with another embodiment of the invention.

### GLOSSARY

The term “sterilizing grade filter” as used herein is meant to denote that the stacked filter material demonstrated zero CFU in all ten samples tested and thus met the Bacterial Retention Requirements for a Sterilizing Grade Filter set forth herein.

As used herein, the phrase “non-sterile membrane” is meant to describe an individual membrane which demonstrates at least one CFU when tested according to the Bacterial Retention Requirements for a Sterilizing Grade Filter set forth herein and thus fails the test.

As used herein, the term “stacked filtration material” is meant to denote a filtration material that contains least two fluoropolymer membranes positioned such that one fluoropolymer membrane is on another fluoropolymer membrane.

As used herein, the term “thickness dimension” is the direction of the membrane orthogonal or substantially orthogonal to the length of the membrane.

As used herein, the term “length dimension” is the direction of the membrane orthogonal or substantially orthogonal to the thickness of the membrane.

As used herein, the term “major surface” is meant to describe the top and/or bottom surface along the length of the membrane and is perpendicular to the thickness of the membrane.

As used herein, the term “on” is meant to denote an element, such as an expanded polytetrafluoroethylene (ePTFE) membrane, is directly on another element or intervening elements may also be present.

As used herein, the term “adjacent” is meant to denote an element, such as an ePTFE membrane, is directly adjacent to another element or intervening elements may also be present.

The term “substantially zero microns” is meant to define a distance that is less than or equal to 0.1 microns.

As used herein, the term “free fibrils” is meant to describe fibrils that have two ends, one end is connected to the surface of the membrane and the second end is not connected to the surface of the membrane and extends away or outwardly from the surface of the membrane.

### DETAILED DESCRIPTION

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

It is to be noted that the terms “membrane”, and “ePTFE membrane” may be used interchangeably herein. Also, the terms “stacked filtration member”, “stacked filter member”, and “stacked filtration medium” may be interchangeably used herein. Further, the terms “bacterial filtration material” and “bacterial filter material” may be used interchangeably herein.

The present invention is directed to non-sterile fluoropolymer membranes that, when placed in a stacked or layered orientation, meet the stringent bacterial retention requirements for a sterilizing grade filter without significantly affecting flow rate. Individually, however, the fluoropolymer membranes allow bacteria to pass through. The fluoropolymer membrane(s) may be an expanded polytetrafluoroethylene (ePTFE) membrane that has a bubble point from about 10 psi to about 50 psi, a thickness less than about 10 microns, and a mass/area less than about 10 g/m².

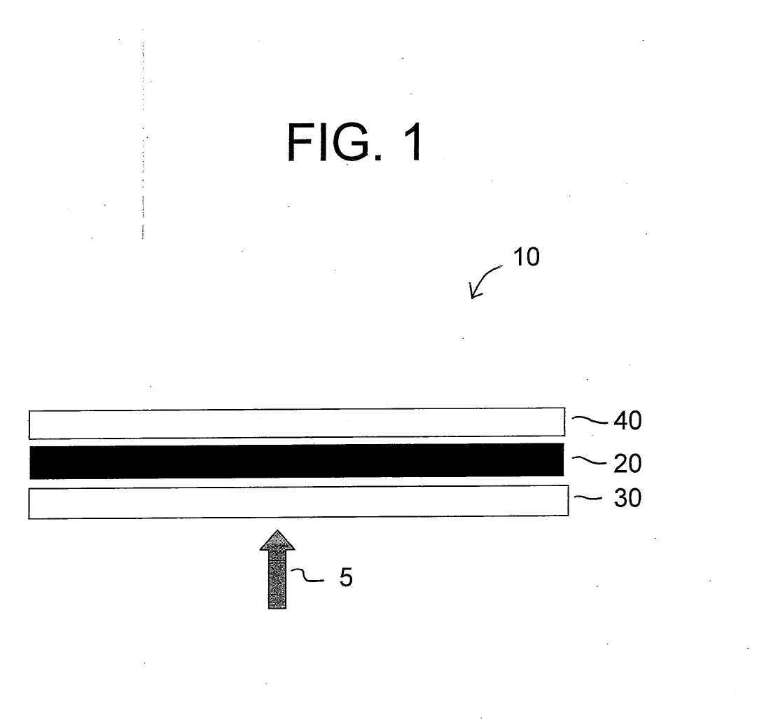

The bacterial filtration material includes at least a first layer of a stacked filter material and at least one fibrous layer that is configured to support the stacked filter material and/or is configured to provide drainage of fluid away from the stacked filter material. FIG. 1 depicts one exemplary orientation of the layers of materials forming the bacterial filtration material 10. As shown, the filtration medium 10 may include a stacked filter material 20, a first fibrous layer 30 forming an upstream drainage layer and an optional second fibrous layer 40 forming a downstream drainage layer. The arrow 5 depicts the direction of fluid flow through the filtration material.

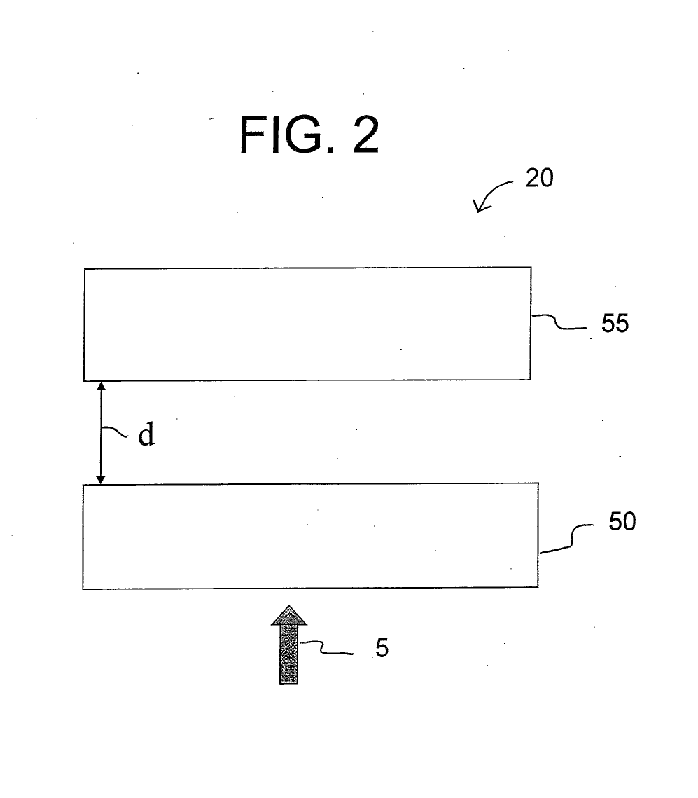

The stacked filter material 20 contains two fluoropolymer membranes 50, 55 positioned in a stacked or layered configuration as shown generally in FIG. 2. The fluoropolymer membrane 50 is positioned adjacent to or on the fluoropolymer membrane 55 such that material flows through the membranes 50, 55 (illustrated by arrow 5). Additionally, fluoropolymer membrane 50 is separated from fluoropolymer membrane 55 by a distance d. The distance d may range from about 0 microns to about 100 microns, from about 0 microns to about 75 microns, from about 0 microns to about 50 microns, or from about 0 microns to about 25 microns. In some embodiments, the distance d is zero or substantially zero microns, less than or equal to 0.1 microns. The distance may also be less than about 100 microns, less than about 75 microns, less than about 50 microns, less than about 25 microns, less than about 20 microns, less than about 15 microns, less than about 10 microns, less than about 5 microns, or less than about 1 micron.

The fluoropolymer membranes 50, 55 may be positioned in a stacked configuration by simply laying the membranes on top of each other. Alternatively, the fluoropolymer membranes may be stacked and subsequently laminated together using heat and/or pressure. Embodiments employing two fluoropolymer membranes that are co-expanded to produce a composite stacked filtration material is also considered to be within the purview of the invention. The composite stacked filtration material may contain two or more layers of fluoropolymer membranes that may be co-extruded or integrated together. In such an embodiment, the first fluoropolymer membrane and second fluoropolymer membrane are in a stacked configuration, but the distance between the first and second fluoropolymer membranes is zero or nearly zero. The composite stacked filtration material has a first major surface and a second major surface. Such a composite stacked filtration material may have a bubble point from about 10 psi to about 50 psi, from about 14 psi to about 20 psi, or from about 21 psi to about 25 psi. Alternatively, the composite stacked filtration material may have a bubble point less than about 50 psi, less than about 35 psi, less than about 30 psi, or less than about 25 psi. Additionally the first and second major surfaces are free or substantially free of fibrils.

Optional support layers may be located between the fluoropolymer membranes. Non-limiting examples of suitable support layers include polymeric woven materials, non-woven materials, knits, nets, and/or porous membranes. The thickness of the support layers may range from about 1 micron to about 100 microns, from about 1 microns to about 75 microns, or from about 1 microns to about 50 microns, or from about 1 microns to about 25 microns.

The fluoropolymer membranes 50, 55 filter bacteria from a fluid stream when the membranes 50, 55 are positioned in the fluid stream. It is to be appreciated that membrane 50 and membrane 55 individually do not meet the requirements for a sterilizing grade filter. However, when positioned in a stacked or layered configuration, such as is shown in FIG. 2, the stacked filter material 10 meets the Bacterial Retention requirements for a Sterilizing Grade Filter set forth herein.

In one or more exemplary embodiment, at least one of the fluoropolymer membranes is a polytetrafluoroethylene (PTFE) membrane or an expanded polytetrafluoroethylene (ePTFE) membrane. Expanded polytetrafluoroethylene (ePTFE) membranes prepared in accordance with the methods described in U.S. Pat. No. 7,306,729 to Bacino et al., U.S. Pat. No. 3,953,566 to Gore, U.S. Pat. No. 5,476,589 to Bacino, or U.S. Pat. No. 5,183,545 to Branca et al. may be used herein.

The fluoropolymer membrane may also include an expanded polymeric material comprising a functional tetrafluoroethylene (TFE) copolymer material having a microstructure characterized by nodes interconnected by fibrils, where the functional TFE copolymer material includes a functional copolymer of TFE and PSVE (perfluorosulfonyl vinyl ether), or TFE with another suitable functional monomer, such as, but not limited to, vinylidene fluoride (VDF). The functional TFE copolymer material may be prepared, for example, according to the methods described in U.S. Patent Publication No. 2010/0248324 to Xu et al. or U.S. Patent Publication No. 2012/035283 to Xu et al. It is to be understood that throughout the application, the term “PTFE” is meant to include not only polytetrafluoroethylene, but also expanded PTFE, expanded modified PTFE, and expanded copolymers of PTFE, such as described in U.S. Pat. No. 5,708,044 to Branca, U.S. Pat. No. 6,541,589 to Baillie, U.S. Pat. No. 7,531,611 to Sabol et al., U.S. Patent Publication No. 2009/0093602 to Ford, and U.S. Patent Publication No. 2010/0248324 to Xu et al.

In addition, the fluoropolymer membrane is thin, having a thickness from about 1 micron to about 15 microns, from about 1 micron to about 10 microns, from about 1 micron to about 7 microns, or from about 1 micron to about 5 microns. Alternatively, the fluoropolymer membrane has a thickness less than about 15 microns, less than about 10 microns, less than about 7 microns, or less than about 5 microns.

The fluoropolymer membranes have a mass/area from about 0.1 g/m² to about 0.5 g/m², from about 0.1 g/m² to about 2 g/m², from about 0.5 g/m² to 1 g/m², from about 1 g/m² to about 1.5 g/m², from about 1.5 g/m² to about 3 g/m², or from about 3 g/m² to about 5 g/m². Also, the fluoropolymer membranes may have an air permeability from about 0.5 Frazier to about 2 Frazier, or from about 2 Frazier to about 4 Frazier, or from about 4 Frazier to about 6 Frazier, or from about 6 Frazier to about 10 Frazier. Further, the fluoropolymer membrane may be rendered hydrophilic (e.g., water-wettable) using known methods in the art, such as, but not limited to, the method disclosed in U.S. Pat. No. 4,113,912 to Okita, et al.

The bubble point of the fluoropolymer membrane may range from about 10 psi to about 50 psi, from about 14 psi to about 20 psi, or from about 21 psi to about 25 psi. Alternatively, the fluoropolymer membrane may have a bubble point less than about 50 psi, less than about 35 psi, less than about 30 psi, or less than about 25 psi.

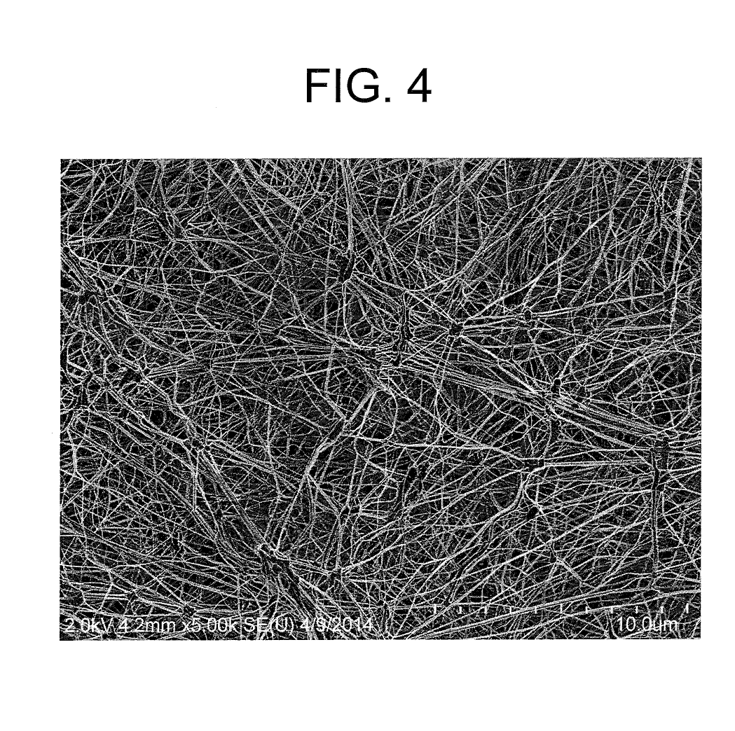

As discussed above, at least one of the fluoropolymer membranes in the stacked filtration member may be an expanded polytetrafluoroethylene (ePTFE) membrane. In a further embodiment, both of the fluoropolymer membranes are ePTFE membranes. The ePTFE membranes may be derived from the same ePTFE membrane, e.g., the two ePTFE membranes may be cut from a larger ePTFE membrane and used in the stacked filtration material. The cut is made orthogonal or substantially orthogonal to the length dimension of the ePTFE membrane, i.e., cut substantially parallel to the thickness dimension. In such an embodiment, the first fluoropolymer membrane 50 and the second fluoropolymer membrane 55 would be the same or nearly the same in measurable properties such as bubble point, thickness, air permeability, mass/area, etc. In such an embodiment, the surface morphology on the surfaces of the ePTFE membranes are the same or substantially the same. Alternatively, the two ePTFE membranes may be derived from separate ePTFE membranes. In this embodiment, the ePTFE membranes 50, 55 would be different. The difference between the two ePTFE membranes may be in pore size, thickness, bubble point, microstructure, or combinations thereof. In addition, the top and bottom surfaces of the ePTFE membranes 50, 55 are free or substantially free of free fibrils. Free fibrils occur in instances where membrane (such as ePTFE) is split, torn, or otherwise fragmented so as to form two membranes from a single parent membrane. The surface of the fluoropolymer membranes 50, 55 may have an appearance such as is shown in FIGS. 4, 5, 7, and 8.

It is to be appreciated that more than two fluoropolymer membranes may form the stacked filter material 20. In addition, the fluoropolymer membranes may be derived from the same fluoropolymer source, from different sources, or a combination thereof. Also, some or all of the fluoropolymer membranes may vary in composition, bubble point, thickness, air permeability, mass/area, etc. from each other.

The fibrous layer in the filtration medium includes a plurality of fibers (e.g., fibers, filaments, yarns, etc.) that are formed into a cohesive structure. The fibrous layer is positioned adjacent to and downstream of the stacked filter material to provide support for the stacked filter material. The fibrous layer may be a woven structure, a nonwoven structure, or a knit structure made using polymeric materials such as, but not limited to polypropylene, polyethylene or polyester.

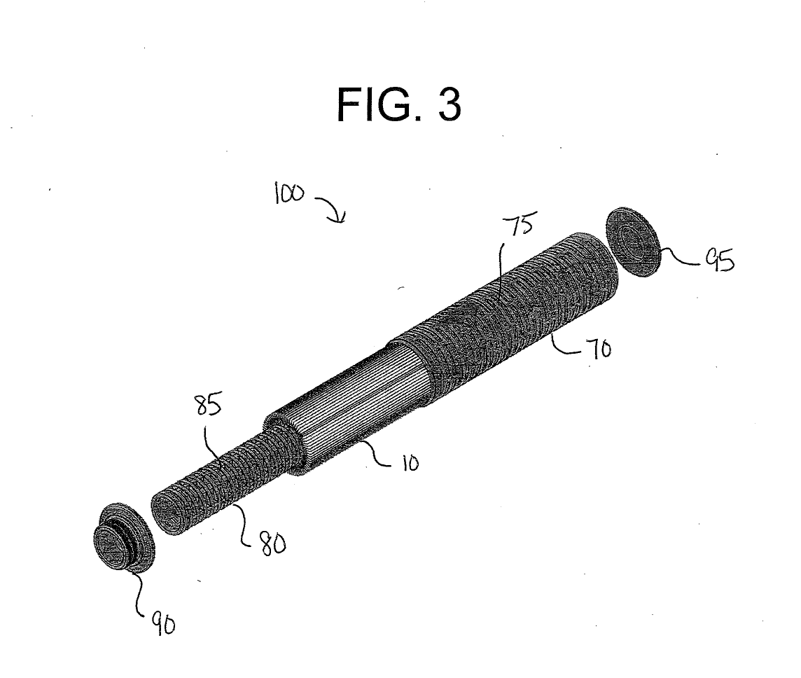

Turning to FIG. 3, the filtration medium 10 may be concentrically disposed within an outer cage 70. The outer cage 70 that has a plurality of apertures 75 through the surface of the outer cage 70 to enable fluid flow through the outer cage 70, e.g., laterally through the surface of the outer cage 70. An inner core member 80 is disposed within the cylindrical filtration medium 10. The inner core member 80 is also substantially cylindrical and includes apertures 85 to permit a fluid stream to flow through the inner core member 80, e.g., laterally through the surface of the inner core member 80. Thus, the filtration medium 10 is disposed between the inner core member 80 and the outer cage 70. The filtration article 100 may be sized for positioning within a filtration capsule (not illustrated).

The filtration device 100 further includes end cap components 90, 95 disposed at opposite ends of the filtration cartridge 100. The end cap components 90, 95 may include apertures (not illustrated) to permit fluid communication with the inner core member 80. Thus, fluid may flow into the filtration cartridge 100 through the apertures and into the inner core member 80. Under sufficient fluid pressure, fluid will pass through apertures 85, through the filtration medium 10, and exit the filtration cartridge 100 through the apertures 75 of the outer cage 70.

When the filtration cartridge 100 is assembled, the end cap components 90, 95 are potted onto the filtration medium 10 with the outer cage 70 and the inner core member 80 disposed between the end cap components 90, 95. The end cap components 90, 95 may be sealed to the filtration medium 10 by heating the end cap components 90, 95 to a temperature that is sufficient to cause the thermoplastic from which the end cap components are fabricated to soften and flow. When the thermoplastic is in a flowable state, the ends of the filtration medium 10 are contacted with the respective end cap components 90, 95 to cause the flowable thermoplastic to imbibe (e.g., to infiltrate) the filtration medium 10. Thereafter, the end cap components 90, 95 are solidified (e.g., by cooling) to form a seal with the filtration medium 10. The assembled filtration cartridge 100 (e.g., with the end cap components potted onto the filtration medium) may then be used in a filtration device such as a filtration capsule. One or both ends of the stacked filtration member 20 and fibrous layers 30, 60 of filtration article 100 may be potted to sealably interconnect the end(s) of the filtration medium 10.

It is to be appreciated that various other configurations of filtration devices may be utilized in accordance with the present disclosure, such as non-cylindrical (e.g., planar) filtration devices. Further, although the flow of fluid is described as being from the outside of the filtration cartridge to the inside of the filtration cartridge (e.g., outside-in flow), it is also contemplated that in some applications fluid flow may occur from the inside of the filtration cartridge to the outside of the filtration cartridge (e.g., inside-out flow).

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

### Test Methods

It should be understood that although certain methods and equipment are described below, other methods or equipment determined suitable by one of ordinary skill in the art may be alternatively utilized.

Bubble Point

The bubble point was measured according to the general teachings of ASTM F31 6-03 using a Capillary Flow Porometer (Model CFP 1500 AE from Porous Materials, Inc., Ithaca, N.Y.). The sample membrane was placed into a sample chamber and wet with SilWick Silicone Fluid (commercially available from Porous Materials, Inc.) having a surface tension of 19.1 dynes/cm. The bottom clamp of the sample chamber consists of a 40 micron porous metal disc insert (Mott Metallurgical, Fannington, Conn.) with the following dimensions (2.54 cm diameter, 3.175 mm thickness). The top clamp of the sample chamber consists of an opening, 12.7 mm in diameter. Using the Capwin software version 6.74.70, the following parameters were set as specified in Table 1. The values presented for bubble point were the average of two measurements.

TABLE 1

| Parameter Set Point | Set Point |
|---|---|
| Maxflow (cc/m) | 200000 |
| Bubflow (cc/m) | 38 |
| F/PT | 50 |
| Minbppres (psi) | 0.1 |
| Zerotime (sec) | 1 |
| V2incr (cts) | 10 |
| Preginc (cts) | 1 |
| Pulse Delay (sec) | 2 |
| Maxpress (psi) | 500 |
| Pulse Width (sec) | 0.2 |
| Mineqtime (sec) | 30 |
| Presslew (cts) | 10 |
| Flowslew (cts) | 50 |
| Eqiter (0.1 sec) | 3 |
| Aveiter (0.1 sec) | 20 |
| Maxpdif (psi) | 0.1 |
| Maxfdif (cc/m) | 50 |
| Startp (psi) | 1 |

Mass Per Area (Mass/Area)

The mass/area of the membrane was calculated by measuring the mass of a well defined area of the sample using a scale. The sample was cut to a defined area using a die or any precise cutting instrument.

Frazier Air Permeability

Air flow was measured using the TexTest Model FX3310 instrument. The air flow rate through the sample was measured and recorded. The Frazier Air Permeability is the rate of flow of air in cubic feet per square foot of sample area per minute when the differential pressure drop across the sample is 12.7 mm (0.5 inch) water column.

Membrane Thickness Using Scanning Electron Micrograph (SEM)

Membranes were sectioned using a cold single-sided razor blade. The sections were mounted on an aluminum SEM stub with conductive double-sided carbon tape. Sections were approximately 5 mm in length. Images were acquired at magnifications of 4500×, 5000×, and 10,000×, a working distance of 3-5 mm, and an operating voltage of 2 kV on a Hitachi(r) SU-8000 Field Emission Scanning Electron Microscope (FE-SEM). Images were recorded at a data size of 2560×1920. Point-to-point thickness measurements of features of interest on the images were measured and recorded using Quartz Imaging(r) PCI software. The MRS-4 calibration standard (Geller MicroAnalytical Laboratory) was to calibrate the FESEM.

Bacterial Retention Test Method

(A) Brevundimonas diminuta Challenge Suspension Preparation

The general methods described in ASTM F838-05 and PDA TR No. 26 were followed. In particular, a bacterial suspension was prepared using lyophilized Brevundimonas diminuta (ATCC® 19146™ from American Type Culture Collection, Manassas, Va.). The lyophilized B. diminuta were re-hydrated with 10 mL of sterile Trypticase Soy Broth (TSB), procured from Becton Dickinson, Sparks, Md. The entire solution was incubated at 30±2° C. for 24 hours.

After incubation was complete, eighty Trypticase Soy Agar (TSA) slants were inoculated, each with 75 micro liter of the above TSB culture. The TSA slants were incubated at 30±2° C. for 48 hours and then stored at −80° C. The TSA slants serve as the seed bacteria for use in the bacterial retention test and can be stored at −80° C. for as long as one year.

One of the stored TSA slants was thawed and re-suspended in 5 mL sterile TSB. The TSA slant solution was then inoculated with 200 mL additional sterile TSB aseptically and then incubated at 30±2° C. for 24 hours.

18 mL TSB culture was inoculated into 4.5 L of sterile Saline Lactose Broth (SLB) procured from Becton Dickinson, Sparks, Md. The SLB culture was set up on the magnetic stirrer inside an incubator and connected to sterile air supply. This culture was incubated at 30±2° C. for 24 hours.

The final bacterial challenge suspension was prepared by adding sterile SLB as a diluent to the culture to reach the desired bacteria concentration of at least 10⁷ CFU/cm². The concentration of viable bacteria in the challenge suspension was determined by performing serial dilution and plating via a spread plate method on TSA plates.

(B) Filtration Test Procedure

A 47 mm disk of a polypropylene non-woven material was placed on top of the metal screen of a filter holder (Part No. DH1-047-10-S, Meissner Filter Products, Camarillo, Calif.). An open ePTFE membrane (i.e., less than about 3 psi in Bubble Point) was placed on top of the non-woven material to protect subsequent ePTFE membranes from mechanical damage. The ePTFE membrane sample (i.e., prepared according to the Example) was placed on top of the open ePTFE membrane without wrinkles. The filter holder was then tightened with clamps. A 0.45 μm PVDF hydrophilic membrane was used for the positive control membrane as part of the test procedure.

Three pressurized vessels were loaded with the bacterial challenge solution, SLB rinse, and IPA respectively. Transfer lines, air tubes, valves and calibrated gas gauges were connected to the vessels aseptically. The pressure was set up at 30 psig throughout the test system and all three transfer lines out of the three pressurized vessels were primed by controlling valves. The filter holder was connected to the challenge suspension vessel.

When hydrophobic ePTFE membranes were tested, the membranes were pre-wetted with about 200 mL of 70% IPA followed by a 600 mL sterile SLB rinse.

At a differential pressure of 30 psid across the sample, the bacterial challenge solution was filtered through the membrane sample. About 160 mL of the filtrate was collected in a 500 mL sterile sample bottle and passed under vacuum through an assay filter assembly consisting of a hydrophilic cellulose acetate membrane of rated pore size 0.45 micron. (Part No. MVHAWGS24, Millipore, Billerica, Mass.). The assaying membrane was then removed from the assembly and placed on a TSA plate.

The plate was placed in the incubator at 30±2° C. for at least 48 hours. After 48 hours B. diminuta colonies had grown on the TSA plates. The bacteria colonies were counted as colony forming units (CFU) and recorded.

(C) Bacterial Retention Requirements for a Sterilizing Grade Filter

Ten ePTFE membrane samples (i.e., each from the same Example) were tested according to the Bacterial Retention Test Procedure. The ePTFE membranes were determined to meet the bacterial retention requirements of a sterilizing grade filter only when all of the ten samples recorded 0 (zero) CFU. If one CFU is recorded, the ePTFE membrane sample failed and did not meet the requirements for a sterilizing grade filter.

### EXAMPLES

### Example 1

A fine powder of polytetrafluoroethylene (PTFE) polymer (DuPont., Parkersbury, W. Va.) was blended with Isopar™ K (Exxon Mobil Corp., Fairfax, Va.) in the proportion of Isopar™ K to fine powder of 0.226 g/g. The lubricated powder was compressed in a cylinder to form a pellet and placed into an oven set at 25° C. The compressed pellet was ram extruded to produce a tape approximately 16.5 cm wide by 0.73 mm thick. The tape was then passed through a set of compression rolls to a thickness of 0.25 mm. The tape was then transversely stretched to approximately 56 cm (i.e., at a ratio of 4.0:1), restrained, then dried in an oven set at 210° C. The dry tape was longitudinally expanded between banks of rolls over a heated plate set to a temperature of 315° C. The speed ratio between the second bank of rolls and the first bank of rolls, and hence the expansion ratio was 12:1. The longitudinally expanded tape was then expanded transversely at an approximate temperature of 385° C. and at a transverse expansion ratio of 12.9:1. The expanded PTFE membrane was then constrained and heated in an oven set at a temperature of 380° C. for approximately 20 seconds.

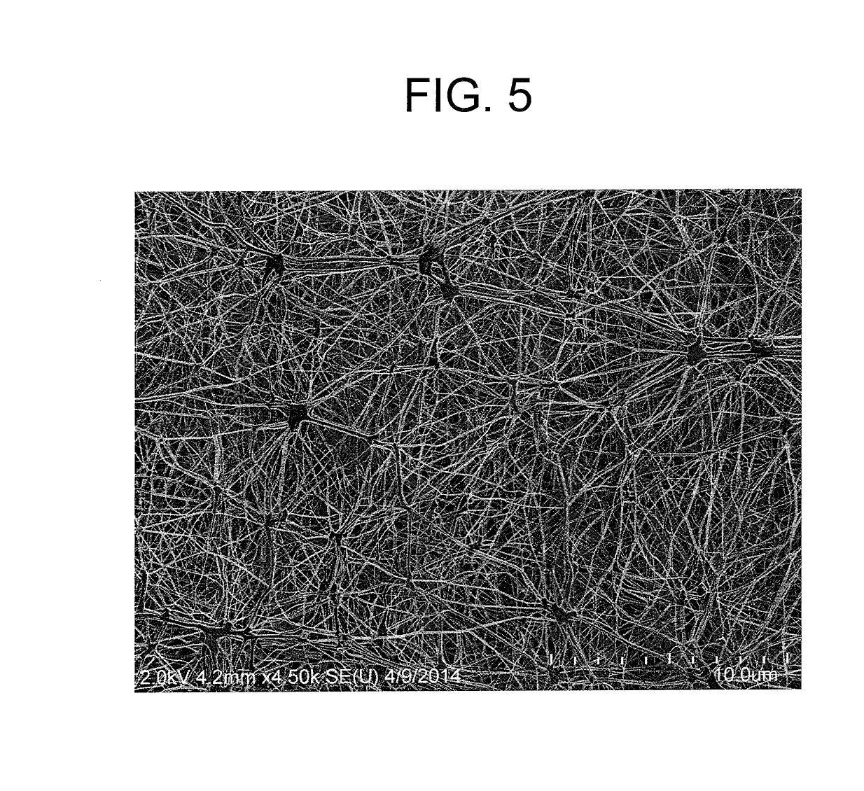

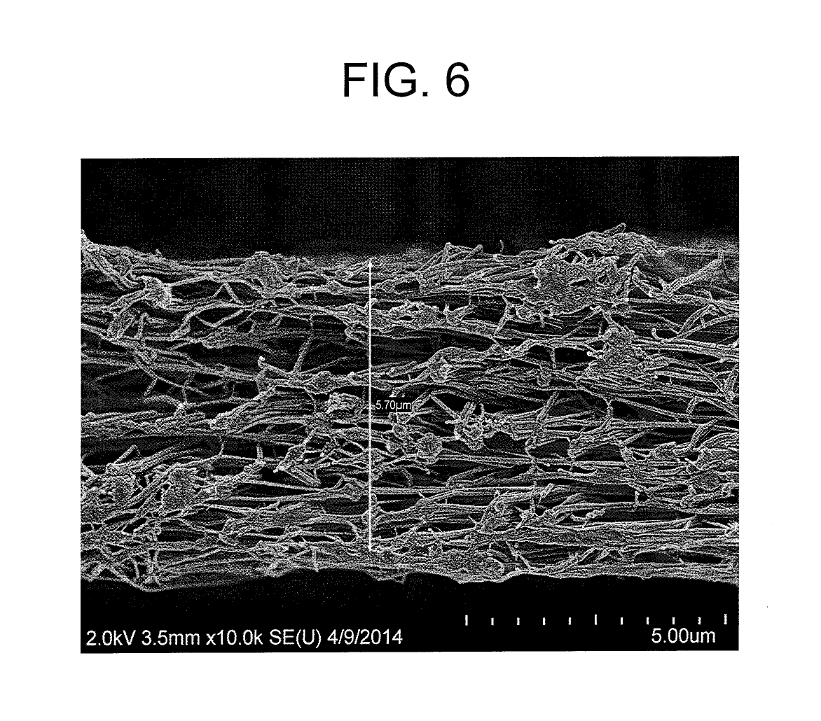

FIG. 4 is a scanning electron micrograph (SEM) of the top surface of the resulting ePTFE membrane taken at 5000×, FIG. 5 is an SEM of the bottom surface of the same ePTFE membrane taken at 4500×, FIG. 6 is an SEM of the cross section of the ePTFE membrane taken at 10,000×. The thickness of the membrane of this example was determined to be 5.7 microns based on the cross-section SEM.

As shown in Table 2, the resulting expanded PTFE (ePTFE) membrane had a Bubble Point of 22.8 psi, Air permeability of 4.4 Frazier and mass per area of 1 g/m². Two of these ePTFE membranes were placed on top of each other in a layered or stacked configuration to form a two-layered stacked filter. The stacked filter had an increased Bubble Point of 28.3 psi. The air permeability of the stacked filter was measured to be 2.1 Frazier.

The two-layered stacked filter was tested in accordance with the Bacterial Retention Test Method set forth herein. Zero CFUs were detected. Thus, the stacked filter was determined to meet bacterial retention requirements of a sterilizing grade filter.

### Example 2

A fine powder of PTFE polymer (DuPont., Parkersbury, W. Va.) was blended with Isopar™ K (Exxon Mobil Corp., Fairfax, Va.) in the proportion of this lubricant to fine powder of 0.234 g/g. The lubricated powder was compressed in a cylinder to form a pellet and placed into an oven set at 16° C. The compressed pellet was ram extruded to produce a tape approximately 16.5 cm wide by 0.73 mm thick. The tape was then passed through a set of compression rolls to a thickness of 0.25 mm. The tape was then transversely stretched to approximately 56 cm (i.e., at a ratio of 4.0:1), restrained, then dried in an oven set at 210° C. The dry tape was longitudinally expanded between banks of rolls over a heated plate set to a temperature of 315° C. The speed ratio between the second bank of rolls and the first bank of rolls, and hence the expansion ratio was 12:1. The longitudinally expanded tape was then expanded transversely at an approximate temperature of 385° C. and at a transverse expansion ratio of 12.9:1. The expanded PTFE membrane was then constrained and heated in an oven set at a temperature of 380° C. for approximately 20 seconds.

As shown in Table 2, the resulting expanded PTFE membrane had a Bubble Point of 18.7 psi, air permeability of 5.5 Frazier and Mass per Area of 1.1 g/m². Two layers of these ePTFE membranes were placed on top of each other in a layered or stacked configuration to form a two-layered stacked filter. The stacked filter had an increased Bubble Point of 21.7 psi. The air permeability of the stacked filter was measured to be 2.7 Frazier.

The two-layered stacked filter was tested in accordance with the Bacterial Retention Test Method set forth herein. Zero CFUs were detected. Thus, the stacked filter was determined to meet bacterial retention requirements of a sterilizing grade filter.

### Example 3

A blend of high molecular weight polytetrafluoroethylene fine powder and lower molecular weight modified polytetrafluoroethylene polymer in accordance with the teachings of U.S. Pat. No. 5,814,405 to Branca, et al. was blended with Isopar™ K (Exxon Mobil Corp., Fairfax, Va.) in the proportion of this lubricant to fine powder of 0.167 g/g. The lubricated powder was compressed in a cylinder to form a pellet and placed into an oven set at 70° C. The compressed pellet was ram extruded to produce a tape approximately 16.5 cm wide by 0.73 mm thick. The tape was then passed through a set of compression rolls to a thickness of 0.25 mm. The tape was then transversely stretched to approximately 56 cm (i.e., at a ratio of 4.0:1), restrained, then dried in an oven set at 210° C. The dry tape was then longitudinally expanded between banks of rolls over a heated plate set to a temperature of 315° C. The speed ratio between the second bank of rolls and the first bank of rolls, and hence the expansion ratio was 12:1. The longitudinally expanded tape was then expanded transversely at an approximate temperature of 300° C. and at a transverse expansion ratio of 18:1. The expanded PTFE membrane was then constrained and heated in an oven set at a temperature of 380° C. for approximately 30 seconds.

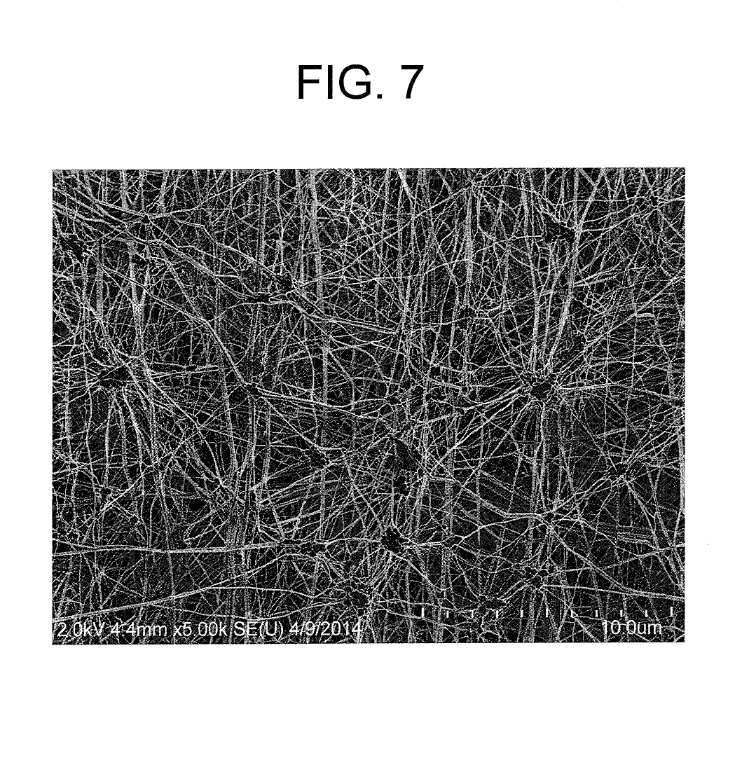

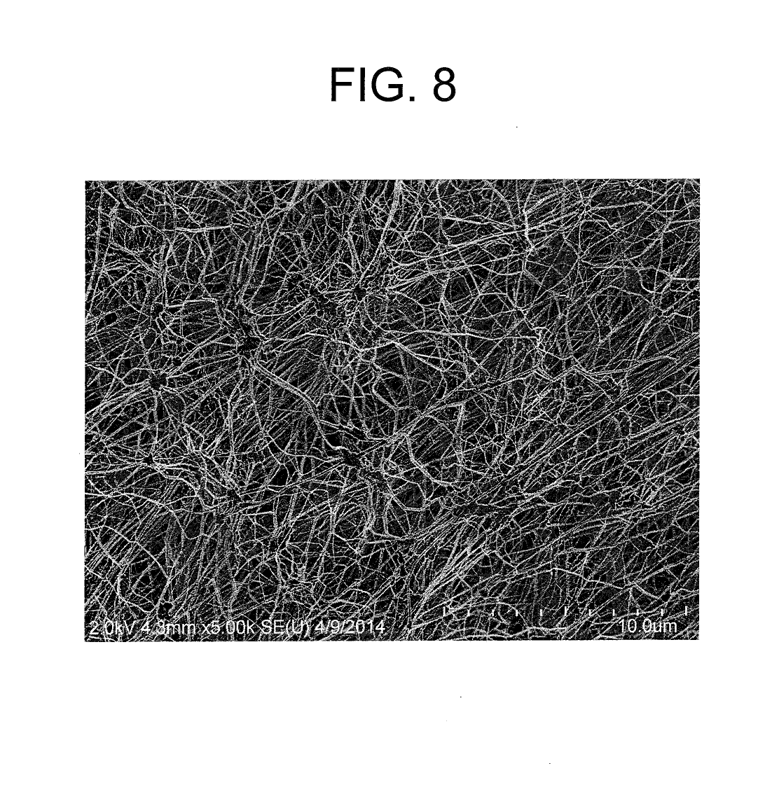

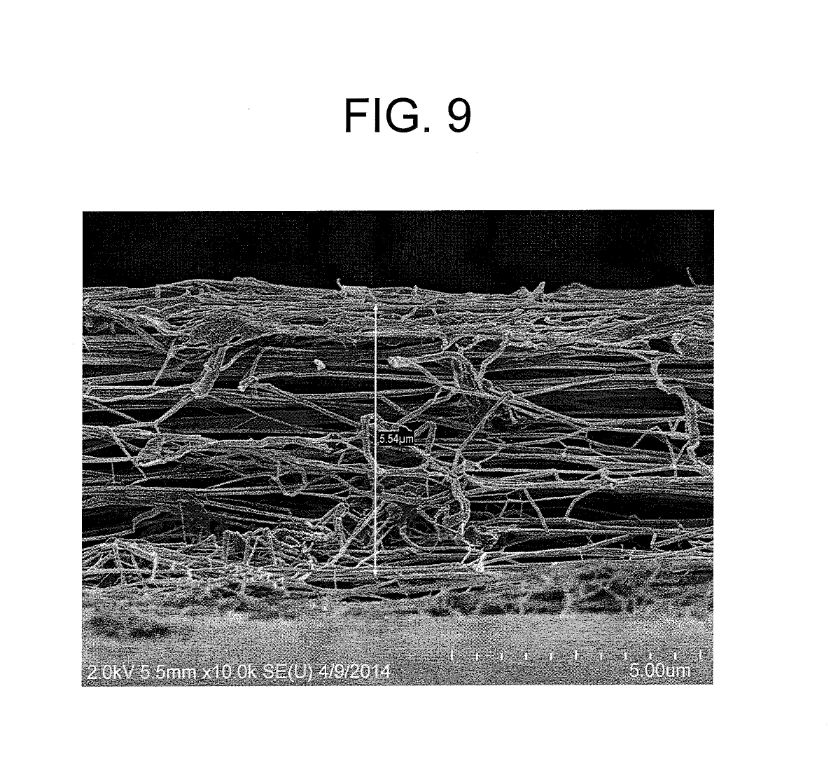

FIG. 7 is a scanning electron micrograph (SEM) of the top surface of the resulting ePTFE membrane taken at 5000. FIG. 8 is an SEM of the bottom surface of the same ePTFE membrane taken at 5000×, FIG. 9 is an SEM of the cross section of the ePTFE membrane taken at 10,000×. The thickness of the membrane of this example was determined to be 5.54 microns based on the cross-section SEM.

As shown in Table 2, the resulting expanded PTFE (ePTFE) membrane had a Bubble Point of 13.5 psi, air permeability of 6.8 Frazier and mass per area of 0.9 g/m². Two of these ePTFE membranes were placed on top of each other in a layered or stacked configuration to form a two-layered stacked filter. The stacked filter had an increased Bubble Point of 18.9 psi. The air permeability of the stacked filter was measured to be 3.4 Frazier. The two-layered stacked filter was tested in accordance with the Bacterial Retention Test Method set forth herein. Zero CFUs were detected. Thus, the stacked filter was determined to meet bacterial retention requirements of a sterilizing grade filter.

### Comparative Example 1

A single layer of expanded PTFE membrane from Example 1 was tested in accordance with the Bacterial Retention Test Method set forth herein. At least one CFU was detected. Thus, a single ePTFE membrane of Example 1 did not meet the bacterial retention requirements of a sterilizing grade filter. The results are set forth in Table 2.

### Comparative Example 2

A single layer of expanded PTFE membrane from Example 2 was tested in accordance with the Bacterial Retention Test Method set forth herein. At least one CFU was detected. Thus, a single ePTFE membrane of Example 2 did not meet the bacterial retention requirements of a sterilizing grade filter. The results are set forth in Table 2.

### Comparative Example 3

A single layer of expanded PTFE membrane from Example 3 was tested in accordance with the with the Bacterial Retention Test Method set forth herein. At least one CFU was detected. Thus, a single ePTFE membrane of Example 3 did not meet the bacterial retention requirements of a sterilizing grade filter. The results are set forth in Table 2.

### Comparative Example 4

A fine powder of PTFE polymer (DuPont., Parkersbury, W. Va.) was blended with Isopar™ K (Exxon Mobil Corp., Fairfax, Va.) in the proportion of this lubricant to fine powder of 0.234 g/g. The lubricated powder was compressed in a cylinder to form a pellet and placed into an oven set at 16° C. The compressed pellet was ram extruded to produce a tape approximately 16.5 cm wide by 0.73 mm thick. The tape was then passed through a set of compression rolls to a thickness of 0.25 mm. The tape was then transversely stretched to approximately 56 cm (i.e., at a ratio of 4.0:1), restrained, then dried in an oven set at 210° C. The dry tape was longitudinally expanded between banks of rolls over a heated plate set to a temperature of 315° C. The speed ratio between the second bank of rolls and the first bank of rolls, and hence the expansion ratio was 8.4:1. The longitudinally expanded tape was then expanded transversely at an approximate temperature of 300° C. and at a transverse expansion ratio of 8.7:1. The expanded PTFE membrane was then constrained and heated in an oven set at a temperature of 380° C. for approximately 30 seconds.

The expanded PTFE membrane thus produced had a Bubble Point of 21.8 psi, air permeability of 3.8 Frazier and Mass per Area of 1.8 g/m². The ePTFE membrane was tested in accordance with the—Bacterial Retention Test Method set forth herein. At least one CFU was detected. Thus, the ePTFE membrane did not meet the bacterial retention requirements of a sterilizing grade filter. The results are set forth in Table 2.

### Comparative Example 5

A blend of high molecular weight polytetrafluoroethylene fine powder and lower molecular weight modified polytetrafluoroethylene polymer in accordance with the teachings of U.S. Pat. No. 5,814,405 to Branca, et al. was blended with Isopar™ K (Exxon Mobil Corp., Fairfax, Va.) in the proportion of this lubricant to fine powder of 0.167 g/g. The lubricated powder was compressed in a cylinder to form a pellet and placed into an oven set at 70° C. The compressed pellet was ram extruded to produce a tape approximately 16.5 cm wide by 0.73 mm thick. The tape was then passed through a set of compression rolls to a thickness of 0.25 mm. The tape was then transversely stretched to approximately 56 cm (i.e., at a ratio of 4.0:1), restrained, and then dried in an oven set at 210° C. The dry tape was longitudinally expanded between banks of rolls over a heated plate set to a temperature of 315° C. The speed ratio between the second bank of rolls and the first bank of rolls, and hence the expansion ratio was 8.4:1. The longitudinally expanded tape was then expanded transversely at an approximate temperature of 300° C. and at a transverse expansion ratio of 14.6:1. The expanded PTFE (ePTFE) was then constrained and heated in an oven set at a temperature of 380° C. for approximately 30 seconds.

The expanded PTFE membrane thus produced had a Bubble Point of 13.1 psi, air permeability of 5.4 Frazier and Mass per Area of 1.8 g/m². The ePTFE membrane was tested in accordance with the—Bacterial Retention Test Method set forth herein. At least one CFU was detected. Thus, the ePTFE membrane did not meet the bacterial retention requirements of a sterilizing grade filter. The results are set forth in Table 2.

### Comparative Example 6

A single layer (47 mm disk) of the membrane of Example 3 was placed in a first sample holder. Another single layer (47 mm disk) of the membrane of Example 3 was
placed in an identical second sample holder. The first and second sample holders were connected such that the membrane layers were separated by a distance of about 3.5 inches. The resulting configuration was tested in accordance with the Bacterial Retention Test Method set forth herein. At least one CFU was detected. Thus, this configuration did not meet the bacterial retention requirements of a sterilizing grade filter. The results are set forth in Table 2.

TABLE 2

| | | | | | Bacterial |
|---|---|---|---|---|---|
| | | | | | Retention To Meet |
| | Bub- | | | | Sterilization |
| | ble | Mass/ | Thick- | | Filter Grade |
| | Point | Area | ness | | Requirements |
| | (psi) | (g/m²) | (micron) | Frazier | (Yes/No) |
| Example 1 | 22.8, | 1 | 5.7 | 4.4, | Yes |
| | 28.3* | | | 2.1* | |
| Example 2 | 18.7, | 1.1 | | 5.5, | Yes |
| | 21.7* | | | 2.7* | |
| Example 3 | 13.5, | 0.9 | 5.54 | 6.8, | Yes |
| | 18.9* | | | 3.4* | |
| Comparative | 22.8 | 1 | | 4.4 | No |
| Example 1 | | | | | |
| Comparative | 18.7 | 1.1 | | 5.5 | No |
| Example 2 | | | | | |
| Comparative | 13.5 | 0.9 | | 6.8 | No |
| Example 3 | | | | | |
| Comparative | 21.8 | 1.8 | | 3.8 | No |
| Example 4 | | | | | |
| Comparative | 13.1 | 1.8 | | 5.4 | No |
| Example 5 | | | | | |
| Comparative | 13.5 | 0.9 | | 6.8 | No |
| Example 6 | | | | | |

*indicates 2 layer stacked filter measurements

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A stacked bacterial filter material comprising:
a first non-sterile fluoropolymer membrane having a first major surface and a second major surface; and
a second non-sterile fluoropolymer membrane positioned on one of said first major surface and second major surface a distance from said first non-sterile fluoropolymer membrane,
wherein said distance is less than 100 microns,
wherein said first and second major surfaces are substantially free of free fibrils,
wherein said first and second fluoropolymer membranes each have a bubble point from about 10 psi to about 50 psi,
wherein said first and second fluoropolymer membranes each have a thickness less than about 10 microns, and
wherein said stacked bacterial filtration material passes the Bacterial Retention Requirements for a Sterilizing Grade Filter.

2. The stacked bacterial filter material of claim 1, wherein said first and second fluoropolymer membranes each have a mass/area from about 0.1 g/m² to about 2 g/m².

3. The stacked bacterial filter material of claim 1, wherein at least one of said first and second fluoropolymer membranes is an expanded polytetrafluoroethylene membrane.

4. The stacked bacterial filter material of claim 1, wherein said first and second fluoropolymer membranes are derived from a parent fluoropolymer membrane divided in a direction perpendicular to a length direction of said parent fluoropolymer membrane.

5. The stacked bacterial filter material of claim 1, wherein said at least one of said first non-sterile fluoropolymer membrane and said second non-sterile fluoropolymer membrane is rendered hydrophilic.

6. The stacked bacterial filter material of claim 1, wherein said first and second fluoropolymer membranes are laminated to each other.

7. The stacked bacterial filter material of claim 1, wherein said first and second fluoropolymer membranes form a composite stacked filtration material.

8. The stacked bacterial filter material of claim 7, wherein composite stacked filtration material has a bubble point from about 10 psi to about 50 psi.

9. A bacterial filtration material comprising:
a stacked filter material comprising:
a first non-sterile fluoropolymer membrane having a first major surface and a second major surface; and
a second non-sterile fluoropolymer membrane positioned on said first major surface a distance from said first major surface, and
a first fibrous layer positioned on said stacked filter material,
wherein said distance is less than 100 microns,
wherein at least one of said first and second fluoropolymer membranes are derived from a parent fluoropolymer membrane divided in a direction perpendicular to a length direction of said parent fluoropolymer membrane,
wherein said first and second fluoropolymer membranes each have a bubble point from about 10 psi to about 50 psi,
wherein said first and second fluoropolymer membranes each have a thickness less than about 10 microns, and
wherein said stacked bacterial filtration material passes the Bacterial Retention Requirements for a Sterilizing Grade Filter.

10. The bacterial filtration material of claim 9, wherein said first and second fluoropolymer membranes are derived from a parent fluoropolymer membrane divided in a direction perpendicular to a length direction of said parent fluoropolymer membrane

10. The bacterial filtration material of claim 9, further comprising a second fibrous layer positioned on said stacked filter material on a side opposing said first fibrous layer.

11. The bacterial filtration material of claim 9, wherein said first and second fluoropolymer membranes each have a bubble point from about 10 psi to about 50 psi.

12. The stacked bacterial filter material of claim 9, wherein said first and second fluoropolymer membranes each have a thickness less than about 10 microns.

13. The stacked bacterial filter material of claim 9, wherein said first and second fluoropolymer membranes each have a mass/area from about 0.1 g/m² to about 2 g/m².

14. The stacked bacterial filter material of claim 9, wherein at least one of said first and second fluoropolymer membranes is an expanded polytetrafluoroethylene membrane.

15. The stacked bacterial filter material of claim 9, wherein said distance is substantially zero microns.

16. The stacked bacterial filter material of claim 9, wherein said first and second fluoropolymer membranes are laminated to each other.

17. The stacked bacterial filter material of claim 9, wherein said first and second fluoropolymer membranes form a composite stacked filtration material.

18. The stacked bacterial filter material of claim 17, wherein said composite stacked filtration material has a bubble point from about 10 psi to about 50 psi.

19. The stacked bacterial filter material of claim 17, wherein said at least one of said first non-sterile fluoropolymer membrane and said second non-sterile fluoropolymer membrane is rendered hydrophilic.

20. A stacked composite bacterial filter material comprising:
a composite stacked filtration material comprising a first non-sterile fluoropolymer membrane and a second non-sterile fluoropolymer membrane, said stacked filtration material having a first major surface and a second major surface,
wherein said first and second major surfaces are substantially free of free fibrils,
wherein said composite stacked filtration material has a bubble point from about 10 psi to about 50 psi, and
wherein said first and second fluoropolymer membranes each have a thickness less than about 10 microns, and
wherein said stacked bacterial filtration material passes the Bacterial Retention Requirements for a Sterilizing Grade Filter.

21. The stacked bacterial filter material of claim 20, wherein said first and second fluoropolymer membranes are co-extruded to form said composite stacked filtration material.

22. The stacked bacterial filter material of claim 20, wherein said first and second fluoropolymer membranes are laminated to form said composite stacked filtration material.

23. The stacked bacterial filter material of claim 20, wherein said at least one of said first non-sterile fluoropolymer membrane and said second non-sterile fluoropolymer membrane is rendered hydrophilic

24. The stacked bacterial filter material of claim 20, wherein said first and second fluoropolymer membranes each have a mass/area from about 0.1 g/m² to about 2 g/m².

25. The stacked bacterial filter material of claim 20, wherein said first and second fluoropolymer membranes are co-expanded to form said composite stacked filtration material.
